(19) United States
(12) Patent Application Publication
(10) Pub. No.: US 2026/0030908 A1
(43) Pub. Date: Jan. 29, 2026

(54) SYSTEM AND METHOD FOR REDUCING PROCESSING WHEN GENERATING ANIMAL CERTIFICATES

(71) Applicant: GlobalVetLink, L.C., Ames, IA (US)

(72) Inventor: Stephen James Adamson, Des Moines, IA (US)

(73) Assignee: GlobalVetLink, L.C., Ames, IA (US)

(21) Appl. No.: 19/276,188

(22) Filed: Jul. 22, 2025

Related U.S. Application Data
(60) Provisional application No. 63/676,052, filed on Jul. 26, 2024.

(51) Int. Cl. G06V 30/41; G06F 16/955; G06F 40/177; G06V 30/162

(52) U.S. Cl. CPC G06V 30/41; G06F 16/955; G06F 40/177; G06V 30/162

(57) ABSTRACT

A method is provided for reducing processing when generating a certificate for an animal. The method can include obtaining, by one or more processors, a record related to an animal and taking, by the one or more processors, a screenshot of the record. The method can also include converting, by the one or more processors, the screenshot of the record to grayscale to form a grayscale screenshot and parsing, by the one or more processors, the grayscale screenshot for data related to a determined certificate. The method may also include generating, by the one or more processors, the determined certificate based on the data parsed from the grayscale screenshot.

### CROSS-REFERENCE

This application is claims priority to and the benefit of U.S. Provisional Application No. 63/676,052, filed Jul. 26, 2024.

### FIELD

This invention relates to methods and systems for reducing processing when generating animal certificates.

### BACKGROUND

Animals are a part of most individuals' day-to-day lives. Whether an animal is a pet such as a cat or dog, a horse used to ride or race, cattle used to feed individuals, animals have a significant effect on the world. As a result, rules and governmental bodies have been formed specifically for animals. Such rules can include ensuring pets are vaccinated, cattle are healthy, or the like. Governmental bodies can include the Food and Drug Administration (FDA), the United States Department of Agriculture (USDA), Animal Plant Health Inspection Services (APHIS), Veterinary Services (VS), or the like. In addition, numerous state-based agencies also exist that regulate animals.

A problem exists in record keeping for animals in general. With so many different organizations having so many differing records and requirements it can become difficult to keep track of records for individual animals. To this end, sometimes individuals take all steps to meet regulatory requirements, but simply lose paperwork, do not fill out paperwork in the correct manner, etc. that makes it difficult to prove the animals meet all regulations. As a result, individuals can have a difficult time selling animals to individuals that are concerned with potentially being scammed by the individual.

In all, there is a need for a system that is easy to use and allows a user to quickly identify their animal and obtain the information they desire related to their animal in a secure computer-based environment. The system needs to provide quick and easy methodology for identifying an animal, along with all records, certificates, paperwork, etc. associated with that animal, and be able to efficiently obtain, process, analyze and save new information related to an animal to provide up to date certificates.

One of the problems with creating a system that allows the analysis and saving of new information is that often information is color coded. Because of the pixel rendering computer programs tend to have difficult times reading information and a significant amount of processing power can be expended attempting to read and copy information. In particular, because different organizations and individuals that have animal information use a variety of ways of displaying information within a documents, difficulties exist.

### SUMMARY

In one or more embodiments, a method is provided for reducing processing when generating a certificate for an animal. The method can include obtaining, by one or more processors, a record related to an animal and taking, by the one or more processors, a screenshot of the record. The method can also include converting, by the one or more processors, the screenshot of the record to grayscale to form a grayscale screenshot and parsing, by the one or more processors, the grayscale screenshot for data related to a determined certificate. The method may also include generating, by the one or more processors, the determined certificate based on the data parsed from the grayscale screenshot.

Optionally, parsing the grayscale screenshot can include analyzing the grayscale screenshot using an artificial intelligence algorithm that selects the data from the grayscale screenshot. In one aspect, obtaining the record can include communicating with a remote animal database at a different location than the one or more processors. In another aspect the method can also include communicating a uniform resource locator the grayscale screenshot to a partner application program interface. In one example the method can also include determining, by the partner application program interface, a universally unique identifier associated with the grayscale screenshot.

In another example the method can also include communicating the universally unique identifier to a service provider. In yet another example the method can additionally include generating a certificate table related to the grayscale screenshot. In one embodiment the method also includes populating the certificate table with network operating system script based on parsing the grayscale screenshot. Optionally, the network operating system script can be JavaScript. Alternatively, the determined certificate can be generated based on the network operating system script in the certificate table.

Optionally, the method can additionally include communicating the universally unique identifier onto a messaging queue. In one aspect, the parsing of the grayscale screenshot can be based on the universally unique identifier on the messaging queue. In another example, the method may include opening a webpage at the uniform resource locator that is related to the grayscale screenshot.

In one or more embodiment an electronic device for reducing processing for generating a certificate for an animal can be provided. The electronic device can include a memory to store executable instructions and one or more processors. When implementing the executable instructions, the one or more processors can be configured to obtain a record related to an animal, take a screenshot of the record and convert the screenshot of the record to grayscale to form a grayscale screenshot. The one or more processors can also be configured to parse the grayscale screenshot for data related to a determined certificate and generate the determined certificate based on the data parsed from the grayscale screenshot.

Optionally, to parse the grayscale screenshot the one or more processors can also be configured to analyze the grayscale screenshot using an artificial intelligence algorithm that selects the data from the grayscale screenshot. In one aspect, to obtain the record the one or more processors can be further configured to communicate with a remote animal database at a different location than the one or more processors. In another aspect, the one or more processors may be further configured to communicate the grayscale screenshot to a partner application program interface that is configured to communicate a universally unique identifier to a service provider. In one example, the one or more processors can be further configured to generate a certificate table related to the grayscale screenshot and populate the certificate table with network operating system script based on parsing the grayscale screenshot. In another example, the one or more processors may be further configured to generate the determined certificate based on the network operating system script in the certificate table. In yet another example the one or more processors can be further configured to communicate a universally unique identifier onto a messaging queue and parse the grayscale screenshot based on the universally unique identifier on the messaging queue.

### BRIEF DESCRIPTION OF THE FIGURES

FIG. 1 is schematic diagram of a system for reducing processing when generating an animal certificate, in an embodiment.

FIG. 2 is a schematic diagram of a screenshot of an electronic device, in an embodiment.

FIG. 3 is a schematic diagram of a screenshot of an electronic device, in an embodiment.

FIG. 4 is a schematic diagram of a screenshot of an electronic device, in an embodiment.

FIG. 5 is a schematic block diagram of an electronic device, in one embodiment.

FIG. 6 is a schematic diagram of a certificate, in one embodiment.

FIG. 7 is a block flowchart illustrating a method for reducing processing when generating a certificate for an animal, in an embodiment.

### DETAILED DESCRIPTION OF THE EMBODIMENTS

The term “obtains” and “obtaining”, as used in connection with data, signals, information and the like, include at least one of i) accessing memory of a remote device or remote server where the data, signals, information, etc. are stored, ii) receiving the data, signals, information, etc. over a wireless communications link a monitoring system and a remote device, and/or iii) receiving the data, signals, information, etc. at a remote server over a network connection. The obtaining operation, when from the perspective of a monitoring system, may include sensing new signals in real time, and/or accessing memory to read stored data, signals, information, etc. from memory within the monitoring system. The obtaining operation, when from the perspective of a remote device, includes receiving the data, signals, information, etc. at a transceiver of the remote device where the data, signals, information, etc. are communicated from a monitoring system and/or a remote server. The obtaining operation may be from the perspective of a remote server, such as when receiving the data, signals, information, etc. at a network interface from a remote device and/or directly from a monitoring system. The remote server may also obtain the data, signals, information, etc. from local memory and/or from other memory, such as within a cloud storage environment and/or from the memory of a workstation or remote programmer.

The present disclosure presents systems and methods for reducing processing when generating a determined certificate for an animal. A certification application can be provided that allows a user to request a determined certificate for a determined animal. The certification application can then obtain a record of the animal from an animal database. Once obtained, a screenshot of the animal record is taken, and the screenshot is converted to grayscale to reduce processing during analysis of the grayscale screenshot. A universally unique identifier can then be associated with the grayscale screenshot and the grayscale screenshot can be analyzed to obtain the data and information needed to populate the requested determined certificate. In one example an artificial intelligence algorithm can be used when parsing the grayscale screenshot for the data required for making the determined certificate. The information and data can then be populated into a certificate table that includes the universally unique identifier. The populated certificate table can then be utilized to generate the determined certificate. If all of the data or information required for generating the certificate is not within the grayscale screenshot, the certificate may be partially populated, or left blank. In one example a message may be provided that identifies the needed information to complete the determined certificate.

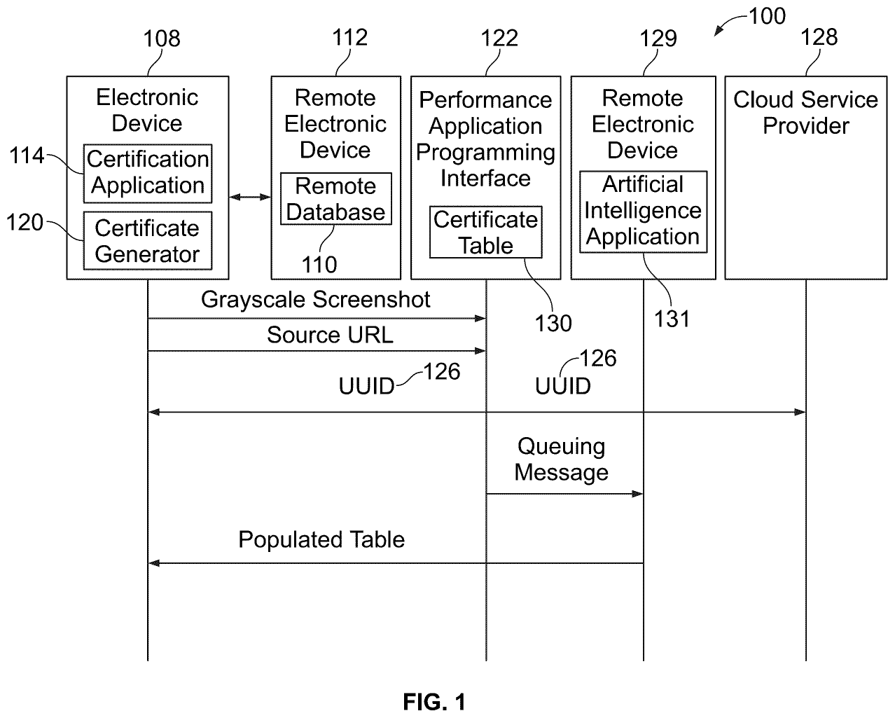

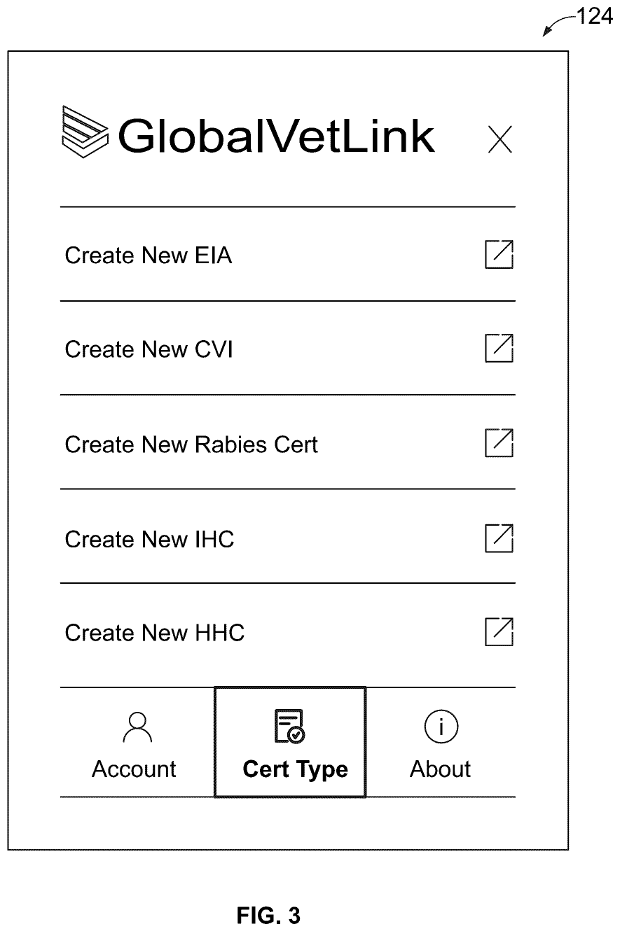

FIG. 1 illustrates a certification system 100 that may be used to create and/or verify an animal certificate (FIG. 3). In one example, the animal certificate is for an animal. In one example the animal can be part of a herd. Alternatively, the animal can be a domesticated animal such as a pet. The animal may include a cow, swine, chicken, equine, bovine, goat, sheep, fish, dog, cat, avian, or the like, and the herd may include livestock, a school of fish, a pack of two or more animals, etc. In one example, the herd has at least ten animals.

The certification system 100 may include an electronic device 108 such as a laptop computer, computer processing unit (CPU), smart phone, smart watch, iPad, tablet, FitBit, etc. The electronic device 108 can include one or more processors used to make determinations, calculations, estimations, operate software, perform methods, perform algorithms, etc. The one or more processors may utilize algorithms, look-up tables, decision trees, artificial intelligence, OCR, or the like in forming the animal certificate, verifying the animal certificate, sending or transmitting the animal certificate, converting the animal certificate into digital file, or the like.

In addition, the electronic device 108 can have a memory or storage device that can include a certification application 114. The certification application 114 is configured to provide instructions for execution by components of the electronic device 108 including the one or more processors to provide security, obtain data and information, analyze data and information, make determinations, create a certificate, or the like.

The electronic device 108 can also include a transceiver for communicating with an animal database 110 of a remote electronic device 112 to obtain animal data. In one example the animal database is remote from the electronic device 108 and communication can be provided over a network. In one example, a transceiver may utilize a communication protocol such as Wi-Fi, Bluetooth, other short range telemetric connection, or the like to operate the communication protocol in a peer-to peer mode. Alternatively the animal database can be in the memory, in a cloud, etc. The animal database can include animal data including information, pictures, immunization records, transportation records, feed schedules, vaccination records, veterinarian records, or the like associated with the animal 104. Such data and information can be obtained from public databases, private databases, input into the animal database, etc.

The certification application 114 may also include a certificate generator 120. A certificate generator 120 may receive information from the memory in order to generate a certificate that may be used by the owner of an animal or herd. In one example, the certificate generator 120 described in U.S. patent Ser. No. 15/311,467 entitled System and Method for Predicting Effectiveness of Animal Treatments to Mahar that is incorporated in full herein, is the certificate generator 120.

The certification application 114 can be configured to obtain a browser extension in any browser chosen by a user. In example embodiments the browser can be Google Chrome™, Mozilla Firefox™, Apple Safari™, Opera™, Microsoft Edge™, Internet Explorer™, or the like. Once the user is at a website that grants them access to the certification application, a user can indicate that they desire to create a certificate (i.e., determined certificate) with the certificate generator 120. In one example the certification application 114 determines whether the user has a valid token. A token as used herein is an element of a programming language. In examples a token can be a pin number, unique identifier, a word or words, operators, or the like. If a token already exists in the browser for the user, then the user is automatically granted access to the certification application 114.

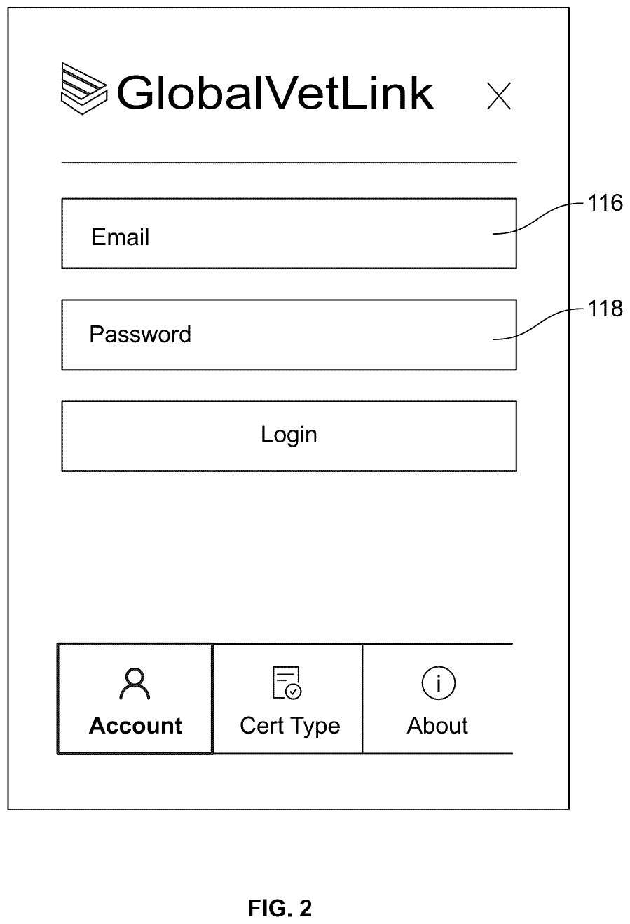

If a user does not have a token in the browser to gain access to the certification application 114, then certification application 114 prompts the user to provide a username and password into a username prompt 116 and password prompt 118 (FIG. 2). The username and password can be used as the token, to generate the token, or the like. In one example the username and password are passed or sent to a partner application programming interface 122 (PAPI) that is a portable interface to hardware performance counters for the one or more processors 110 of the electronic device 108. The PAPI 122 can then generate a token. In one example the token can be a non-expiring token. Still, the token grants access to utilizing the certification application 114.

Once the certification application 114 is accessed, the certification application 114 can provide a popup screen 124 (FIG. 3) that provides one or more options to a user. The user can navigate through the certification application 114 to identify an animal. Once selected, the certification application 114 obtains data related to the selected and identified animal and displays the animal data, or animal record, on the display. In one example, the animal data can be obtained from the animal database of the electronic device, from over a network and from a remote database 110 of a remote electronic device 112, or the like. In one example, the remote animal database can be that of a service provider, veterinary, animal rescue, federal database, state database, or the like.

Once an animal is identified by the user the certification application 114 can provide a user with certificate types for the animal as provided on the popup screen 124. In examples the certificate type can be based on medications, vaccinations, animal type, animals, animal location, animal movement data, or the like. When a user selects the determined certificate, the certification application 114 obtains a screenshot of the animal record that is on the display. The certification application 114 can then convert the screenshot to grayscale. The grayscale provided herein can provide a static number of shades between black and white and may present monotone coloring. By converting the screenshot to grayscale, extracting information from the screenshot is facilitated and the amount of processing power for the extraction is reduced. In one example battery life is saved as a result of the reduction in processing power by converting to grayscale. After the certification application 114 coverts the screenshot to grayscale, the converted grayscale screenshot along with a source uniform resource locator (URL) can be transmitted or sent to the PAPI 122.

The PAPI 122 can then generate a universally unique identifier (UUID) 126. In one example the UUID can be a 128-bit label associated with the converted grayscale screenshot. The UUID provides additional security for the converted grayscale screenshot as the converted grayscale screenshot is transmitted or sent to different network locations. In one example, the converted grayscale screenshot along with the UUID 126 can be sent to a cloud service provider 128. The cloud service provider 128 can include hardware and software to store information and data, process information, or the like. The cloud service provider 128 in one example may include one or more processors, a memory or storage device, a transceiver, or the like. In another example, the cloud service provider can be S3™. In one example, the grayscale screenshot can be saved in a memory, storage device, or the like at the cloud service provider 128 using the UUID.

When the PAPI 122 receives the grayscale screenshot with the UUID and sends them to the cloud service provider 128, the PAPI 122 makes a record of the grayscale screenshot and UUID to allow retrieval of the grayscale screenshot as needed. By storing the grayscale screenshot at the cloud service provider 128 the memory of the electronic device 108 is not burdened, improving processing of the electronic device 108. In one example, to create the record a determined certificate table 130 can be formed that includes entries related to grayscale screenshots and UUIDs saved at either the PAPI 122 or the cloud service provider 128. In one example the certificate table 130 can be populated with raw data that can be used to generate a determined certificate using the raw data. In one example, the PAPI 122 can drop the UUID on a messaging queue for processing and send the certification application 114 the UUID to allow the certification application to retrieve the grayscale screenshot from the cloud service provider 128. In one example the PAPI 122 can send the messaging queue to a remote electronic device 129 that includes an artificial intelligence application 131 or algorithm for parsing information from the grayscale screenshot. Alternatively, the certification application 114 itself may include the artificial intelligence application and parsing may occur at the electronic device 108. In one example embodiment the remote electronic device 129 having the artificial intelligence application 131 may be the same electronic device that has the remote database from which the animal data and screenshot is originally obtained.

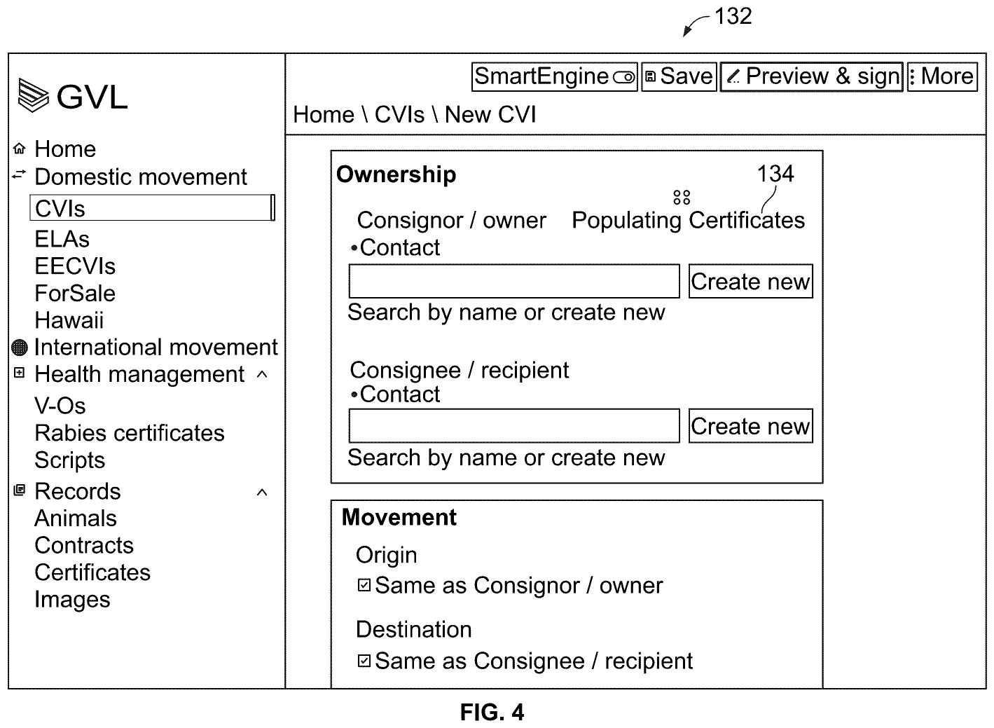

Using the UUID, the certification application 114 can open a new tab 132 (FIG. 4) on the display of the electronic device. In one example the URL address of the new tab 132 can be related to the UUID. In one example the grayscale screenshot that is in the certificate table automatically opens based on the UUID. Alternatively, if additional processing time is needed for loading of the grayscale screenshot a “please wait” message 134 can be prompted on the display. The certification application 114 can continuously check the certificate table to see if the grayscale screenshot has loaded. In one example the certification application 114 checks at least once every second to see if the grayscale screenshot has loaded. In another embodiment the certification application 114 checks once every two seconds, while in other example embodiments the certification application 114 checks more frequently than once every one second.

Once the grayscale screenshot of the patient record screen has loaded, in one example the certification application 114 can receive the message from the message queue and send the grayscale screenshot to an artificial intelligence algorithm such as a large learning model (LLM) with a determined prompt so that information and data can be parsed from the grayscale screenshot. Alternatively such analysis can occur at a remote electronic device 131 that includes the LLM. To this end, the artificial intelligence application 131 can analyze the grayscale screenshot with the LLM and parse out JavaScript Object Notation (JSON) of the grayscale screenshot for data related to the owner, animal, or the like. In one example the JSON can be considered a text-based format for representing structured data that is based on JavaScript object syntax.

In example embodiments the LLM can be used to parse out the data required by the determined certificate chosen by a user. To that end, the data collection system deployed may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems.

Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like.

In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for verifying an animal, generating a determined certificate, or the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined feed schedule or transportation schedule, data from various sensors, and location and/or position data. The neural network can be trained to generate an output based on these inputs, with the output representing a determined certificate that includes identifying indicia, or verification of data needed for completion of a determined certificate.

During operation of one embodiment, a determination can occur by processing the inputs through the parameters of the neural network to generate a value at the output node designating information for the determined certificate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the determined certificate can be generated. Additionally, the success metric may be a combination of the optimized outcomes, which may be weighed relative to each other.

The controller can use this artificial intelligence or machine learning to receive input (e.g., a location or change in location of an animal), use a model that associates locations with different animal characteristics and/or parameters to verify the identity of an animal (e.g., the animal selected using the model). The controller may receive additional input of animal that was selected, such as analysis of noise or interference in communication signals (or a lack thereof), operator input, or the like, which indicates whether the machine-selected animal provided a desirable (e.g., correct) outcome or not. Based on this additional input, the controller can change the model, such as by changing which animal would be selected when a similar or identical location or change in location is received the next time or iteration. The controller can then use the changed or updated model again to select an animal, receive feedback on the selected animal, change or update the model again, etc., in additional iterations to repeatedly improve or change the model using artificial intelligence or machine learning.

If data can be parsed and obtained from the grayscale screenshot, such data, provided in a JSON format, can then be input into the certificate table related to the determined certificate for population of the determined certificate. In one example, because of the use of grayscale, less variables exist for the LLM to analyze resulting in less processing time and saved energy.

If the data required to generate the determined certificate does not exist in the grayscale screenshot of the patient record, the certification application 114 can provide an error message. In one example the error message can include the information that is missing for the determined certificate to be completed. Alternatively, in another example if some of the information is provided, the information that exists can be provided on the certification and an indication of the information still needed can be prompted on the screen. In yet another example, if all of the information needed to complete the certificate is available, the determined certificate is populated accordingly. In an example, during the processing time the display screen may provide a prompt such as a “please wait” prompt to inform the user that processing is still occurring.

While in one example embodiment the certification application can automatically parse and provide information, in other examples workers at the remote electronic device 129 can receive the message queues. In such an embodiment the LLM can still be used to identify data from the grayscale screenshot and a user can populate JavaScript-based network operating system (JNOS) script into the certificate table to create the determined certificate. In one such example, the certification application can provide the results of the LLM in a popup or display screen that can be checked by a user before populating the determined certificate. In this manner, until the machine learning algorithm is considered sufficient or accurate enough that human supervision is no longer required, a check can be provided. In addition, if an error occurs, the user can provide this information to the LLM to assist the LLM in becoming more accurate with determinations. In another example, the UUID can be used to generate a unique stamp or indicia that can be input into the certificate table and printed on the determined certificate by the certificate generator 120. In this manner, when the user receives the determined certificate, an indication is provided that the determined certificate was generated using the certification application 114.

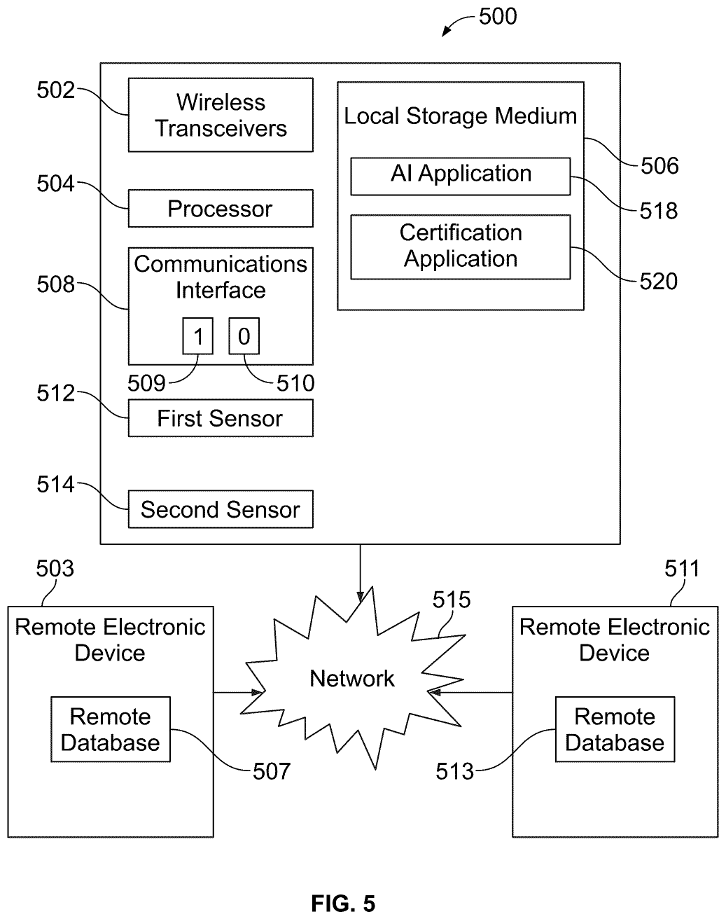

FIG. 5 illustrates a simplified block diagram of the electronic device 500. In one example the electronic device can be the primary electronic device of FIG. 1. While described as the electronic device, in other embodiments the device illustrated may be a remote electronic device. The electronic device 500 includes components such as one or more wireless transceivers 502, one or more processors 504 (e.g., a microprocessor, microcomputer, application-specific integrated circuit, etc.), and one or more local storage medium (also referred to as a memory portion) 506.

Each transceiver 502 can utilize a known wireless technology for communication. Exemplary operation of the wireless transceivers 502 in conjunction with other components of the electronic device 500 may take a variety of forms and may include, for example, operation in which, upon reception of wireless signals, the components of electronic device 500 detect communication signals from the remote electronic devices 503 and the transceiver 502 demodulates the communication signals to recover incoming information, such as responses to inquiry requests, voice and/or data, transmitted by the wireless signals. The one or more processors 504 format outgoing information and convey the outgoing information to one or more of the wireless transceivers 502 for modulation to communication signals. The wireless transceiver(s) 502 conveys the modulated signals to a remote device, such as a cell tower or a remote server (not shown).

The local storage medium 506 can encompass one or more memory devices of any of a variety of forms (e.g., read only memory, random access memory, static random-access memory, dynamic random-access memory, etc.) and can be used by the one or more processors 504 to store and retrieve data. The data that is stored by the local storage medium 506 can include, but need not be limited to, operating systems, applications, obtained animal data, and informational data. Each operating system includes executable code that controls basic functions of the device, such as interaction among the various components, communication with external or remote devices via the wireless transceivers 502, and storage and retrieval of applications and context data to and from the local storage medium 506. In one example, the transceivers can be in communication with a remote electronic device 503 that includes a remote animal database 507. In addition, the transceivers can also be in communication with other remote devices 511 that have other remote animal databases 513 to communicate animal data and determinations made by the one or more processors 502 and to obtain animal data from one or more remote electronic devices 503. To this end, in one example the remote electronic device 503 can be a service provider that includes an animal database that includes animal data from numerous animal databases. Such numerous animal databases can include regulatory databases including state, federal, and municipal databases. In another example the animal databases can include veterinary databases, feed databases, animal movement databases, or the like. All such databases described can be other remote animal databases 513. In this manner, the electronic device can communicate with numerous other electronic devices and storage devices over a network 515 to obtain animal data and information.

The electronic device 500 in one embodiment also includes a communications interface 508 that is configured to communicate with a network resource. Communications interface 508 can include one or more input devices 509 and one or more output devices 510. The input and output devices 509, 510 may each include a variety of visual, audio, and/or mechanical devices. For example, the input devices 509 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 510 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 510 may include a touch sensitive screen, a non-touch sensitive screen, a text-only display, a smart phone display, an audio output (e.g., a speaker or headphone jack), and/or any combination thereof.

The electronic device 500 can also include a first sensor 512, a second sensor 514, an artificial intelligence (AI) application 518, and certification application 520 as described in relation to FIG. 1. All of these components can be operatively coupled to one another, and can be in communication with one another, by way of one or more internal communication links, such as an internal bus. The first sensor 512 and the second sensor 514 both function to obtain animal data. The types of information can include visual, auditory, haptic, infrared, or the like. Example sensors can include cameras, microphones, scanners, infrared cameras, or the like.

The AI application 518 and the certification application 520 in one embodiment are stored within storage medium 506 and each include executable code. Both the AI application 518 and the certification application 520 obtain information, including animal data, from the first sensor 512, second sensor 514, along with other sensors, information input by a user, a remote device, databases, remote databased, etc. For example, the AI application 518 may obtain the animal data related to a particular animal and the environment of the animal to make determinations related to the identity of the animal and health of the animal. The AI application 518 may also receive auxiliary animal data from any database of remote device 503, 511 related to that contain information about a particular animal.

Each remote device 503, 511 may have an animal database 507, 513, or memory/storage device for storing information about an animal, herd, flock, or the like. This information may include animal birthday, age, vaccines, feed, weight, family information, health problems, weight gain or loss, heart rate, or the like obtained from the sensors 512, 514. For example, information from a laboratory computing device may include contact information (e.g., name, address and telephone numbers), one or more tube numbers (e.g., a uniquely identifying number identifying a sample within the laboratory), date received, date reported (e.g., the date the test results are reported), test results (e.g., positive or negative), and a signature (e.g., a digital signature indicating that the test results are entered by a certified laboratory technician). The remote device databases 507, 513 can also include animal information related to the managing and caring for animals such that data resulting from lab submission may be processed, together with production performance information, species and genotypic data, and previous treatment results to better predict which treatment has the highest probability of providing a positive impact on a particular animal and/or group of animals, using data of their specific production phase, species category, genotype, and environmental conditions. In all, the remote devices 503, 511 may be used to collect information for analysis to determine the identification of an animal and the health status of such identified animal.

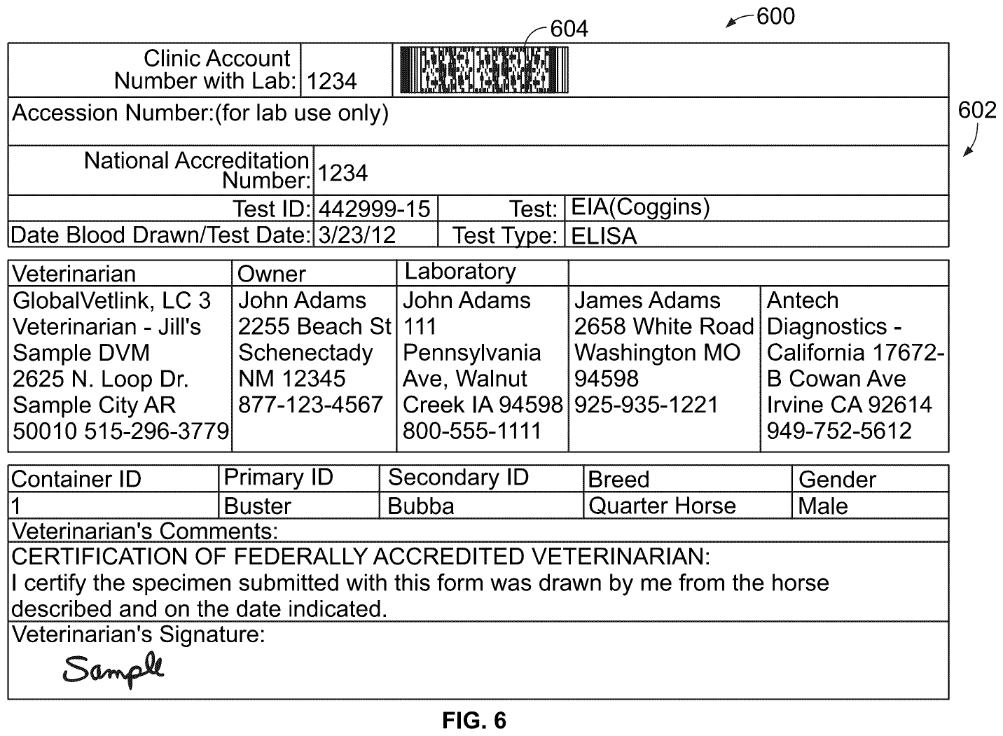

FIG. 6 illustrates an exemplary determined certificate 600 that can be generated by an electronic device. In one example the systems and devices of FIGS. 1-5 are utilized to generate the determined certificate 600. The determined certificate 600 can include animal indicia 602 thereon that provides information related to a particular animal. For example, the animal indicia can include date of birth, age, weight, animal owner, last location, feed information, vaccine records, or the like. In addition, in one example the determined certificate 600 includes at least one indicator 604. The indicator 604, in example embodiments, can be a code, QR code, symbol, picture, or the like that includes information or data embedded therein. In one example, the indicator 604 can be unique to the animal and includes identifying information or data embedded therein that can be scanned or analyzed for verification purposes. In another example the QR code indicates that a certification application was used in creating the determined certificate 600. In one example, the AI, a random number generator, etc. can be utilized when generating the indicator to ensure the uniqueness of the indicator 604.

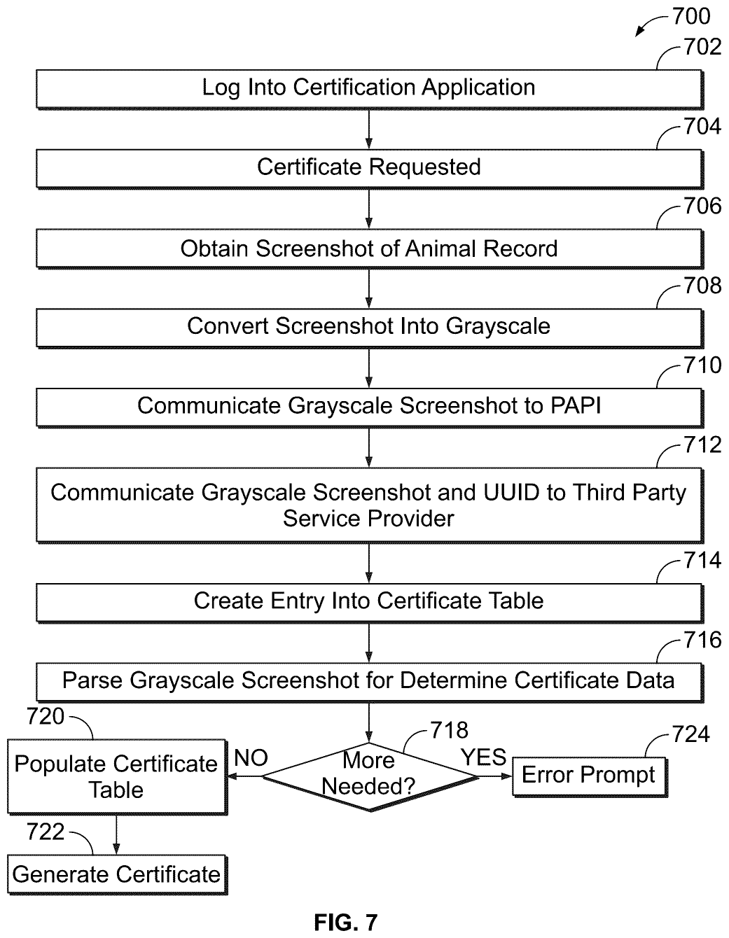

FIG. 7 illustrates a method 700 for reducing processing when generating a determined certificate related to an animal. In example embodiments the systems of FIGS. 1-6 are utilized to perform one or more steps of the method.

At 702, a user logs into a certification application. In one example the certification application can be the certification application as described in relation to FIGS. 1 and 5. In one example a login and password are required to obtain a token to allow access to the certification application. In an example the certification application can be accessed at a website or on the Internet of Things over a network connection.

At 704, a user requests a certificate for an animal. In one example the certificate can be related to allowing the animal to cross state lines. In another example, the certification is related to medical records related to the animal such as vaccine records. In yet another example the determined certificate can be related to a specific vaccination such as rabies, bird flu, mad cow disease, or the like.

At 706, the certification application obtains a screenshot of a record related to the animal. In one example the certification application retrieves the animal record from a database of the electronic device, or a remote database of a remote electronic device. In one example, the electronic device may communicate with a database of a veterinarian or of an animal hospital. In another example the electronic device can communicate and obtain information from a service provider such as a cloud-based service provider that has one or more animal databases.

At 708, once the animal record is obtained, the animal record screenshot is converted into a grayscale screenshot. At 710, the grayscale screenshot is communicated to a PAPI. Because the screenshot is converted to grayscale, the time for transmission may be reduced.

At 712, the PAPI generates a UUID and communicates and saves the grayscale screenshot and accompanying UUID at a third-party service provider. In one example the third-party service provider is a cloud database system. By storing information with the UUID at the third-party service provider memory space of the electronic device is saved.

At 714, the PAPI also creates an entry into a certificate table related to the grayscale screenshot, communicates the UUID to a message queue of the certification application for processing, and provides the UUID to the certification application. In this manner the certification application has the information needed to parse the grayscale screenshot for information and data for the determined certificate requested.

At 716, the electronic device can analyze the grayscale screenshot with a LLM to parse animal data and information needed for the determined certificate requested. In one example the LLM is an artificial intelligence application that is part of the electronic device. Because the screenshot has been converted into grayscale, the parsing operation is facilitated, and processing times are reduced.

At 718 a determination is made whether all of the information or data needed to complete the determined certificate is within the animal record. If all of the information or data needed is parsed and obtained, then at 720, the certification application populates the determined certificate table with JNOS script form information. Again, by using JNOS script, processing time and energy is reduced.

Then at 722, the certification application generates the determined certificate requested. In one example the determined certificate can include indicia indicative that the certification application was used to generate the determined certificate. Once generated the determined certificate can be attached as a file to a communication, such as an email, text, or the like that is communicated to the requester.

If at 718, all of the information is not provided, at 724, the certification application provides a prompt that an error has occurred, and that not enough information is within the animal records. In one example, prior to the error message being communicated, a worker may review the animal record to verify that the LLM did not make a mistake or miss information. If a mistake is made, such information can be provided to the LLM to improve future results. Still, if not enough information is provided, this is communicated to the requester. In one example a message providing the information missing is communicated to the requester. In another example the portions of the determined certificate that can be populated are populated and attached to a message that also includes the messing information. The blank information on the determined certificate also acts to inform the requester of the missing information.

The various methods as illustrated in the Figures and described herein represent exemplary embodiments of methods. The methods may be implemented in software, hardware, or a combination thereof. In various of the methods, the order of the steps may be changed, and various elements may be added, reordered, combined, omitted, modified, etc. Various steps may be performed automatically (e.g., without being directly prompted by user input) and/or programmatically (e.g., according to program instructions).

Various modifications and changes may be made as would be obvious to a person skilled in the art having the benefit of this disclosure. It is intended to embrace all such modifications and changes and, accordingly, the above description is to be regarded in an illustrative rather than a restrictive sense.

Various embodiments of the present disclosure utilize at least one network that would be familiar to those skilled in the art for supporting communications using any of a variety of commercially-available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and AppleTalk. The network can be, for example, a local area network, a wide-area network, a virtual private network, the Internet, an intranet, an extranet, a public switched telephone network, an infrared network, a wireless network, a satellite network and any combination thereof.

In embodiments utilizing a web server, the web server can run any of a variety of server or mid-tier applications, including Hypertext Transfer Protocol (“HTTP”) servers, FTP servers, Common Gateway Interface (“CGI”) servers, data servers, Java servers, Apache servers and business application servers. The server(s) also may be capable of executing programs or scripts in response to requests from user devices, such as by executing one or more web applications that may be implemented as one or more scripts or programs written in any programming language, such as Java®, C, C #or C++, or any scripting language, such as Ruby, PHP, Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU” or “processor”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services, or other elements located within at least one working memory device, including an operating system and application programs, such as a client application or web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Various embodiments may further include receiving, sending, or storing instructions and/or data implemented in accordance with the foregoing description upon a computer-readable medium. Storage media and computer readable media for containing code, or portions of code, can include any appropriate media known or used in the art, including storage media and communication media, such as, but not limited to, volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information, and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

All references, including publications, patent applications and patents, cited herein are hereby incorporated by reference to the same extent as if each reference were individually and specifically indicated to be incorporated by reference and were set forth in its entirety herein.

It is to be understood that the subject matter described herein is not limited in its application to the details of construction and the arrangement of components set forth in the description herein or illustrated in the drawings hereof. The subject matter described herein is capable of other embodiments and of being practiced or of being conducted in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and physical characteristics described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed:

1. A method for reducing processing when generating a certificate for an animal comprising:
obtaining, by one or more processors, a record related to an animal;
taking, by the one or more processors, a screenshot of the record;
converting, by the one or more processors, the screenshot of the record to grayscale to form a grayscale screenshot;
parsing, by the one or more processors, the grayscale screenshot for data related to a determined certificate; and
generating, by the one or more processors, the determined certificate based on the data parsed from the grayscale screenshot.

2. The method of claim 1, wherein parsing the grayscale screenshot includes analyzing the grayscale screenshot using an artificial intelligence algorithm that selects the data from the grayscale screenshot.

3. The method of claim 1, wherein obtaining the record includes communicating with a remote animal database at a different location than the one or more processors.

4. The method of claim 1, further comprising:
communicating a uniform resource locator the grayscale screenshot to a partner application program interface.

5. The method of claim 4, further comprising:
determining, by the partner application program interface, a universally unique identifier associated with the grayscale screenshot.

6. The method of claim 5, further comprising: communicating the universally unique identifier to a service provider.

7. The method of claim 4, further comprising: generating a certificate table related to the grayscale screenshot.

8. The method of claim 7, further comprising: populating the certificate table with network operating system script based on parsing the grayscale screenshot.

9. The method of claim 8, wherein the network operating system script is JavaScript.

10. The method of claim 8, wherein the determined certificate is generated based on the network operating system script in the certificate table.

11. The method of claim 5, further comprising: communicating the universally unique identifier onto a messaging queue.

12. The method of claim 11, wherein the parsing of the grayscale screenshot is based on the universally unique identifier on the messaging queue.

13. The method of claim 4, further comprising: opening a webpage at the uniform resource locator that is related to the grayscale screenshot.

14. An electronic device for reducing processing for generating a certificate for an animal comprising:
a memory to store executable instructions and one or more processors, when implementing the executable instructions, configured to:
obtain a record related to an animal;
take a screenshot of the record;
convert the screenshot of the record to grayscale to form a grayscale screenshot;
parse the grayscale screenshot for data related to a determined certificate; and
generate the determined certificate based on the data parsed from the grayscale screenshot.

15. The electronic device of claim 14, wherein to parse the grayscale screenshot the one or more processors are configured to analyze the grayscale screenshot using an artificial intelligence algorithm that selects the data from the grayscale screenshot.

16. The electronic device of claim 14, wherein to obtain the record the one or more processors are further configured to communicate with a remote animal database at a different location than the one or more processors.

17. The electronic device of claim 14, wherein the one or more processors are further configured to communicate the grayscale screenshot to a partner application program interface that is configured to communicate a universally unique identifier to a service provider.

18. The electronic device of claim 14, wherein the one or more processors are further configured to generate a certificate table related to the grayscale screenshot and populate the certificate table with network operating system script based on parsing the grayscale screenshot.

19. The electronic device of claim 18, wherein the one or more processors are further configured to generate the determined certificate based on the network operating system script in the certificate table.

20. The electronic device of claim 14, wherein the one or more processors are further configured to communicate a universally unique identifier onto a messaging queue and parse the grayscale screenshot based on the universally unique identifier on the messaging queue.
